(19) United States
(12) Patent Application Publication
(10) Pub. No.: US 2005/0210443 A1
(43) Pub. Date: Sep. 22, 2005

(54) Method for processing diagramming

(76) Inventor: Jim A. McAlear, Stittsville (CA)

Correspondence Address: CASSAN MACLEAN, 80 ABERDEEN STREET, SUITE 401, OTTAWA, ON, K1S 5R5, CA

(21) Appl. No.: 10/804,033

(22) Filed: Mar. 19, 2004

(51) Int. Cl. G06F 9/44

(52) U.S. Cl. 717/104; 717/110

(57) ABSTRACT

Methods, interfaces and devices for specifying a software process in a two dimensional diagrammatic framework. The major elements of this framework are software objects, operations on these objects, data flow and interaction operations between these objects, parameter specifications and a control flow context for these operations (samples of how these are represented in diagrams are shown in FIG. 1—which shows how a process can be specified that counts and sums the numbers within a file and writes the average to the system console). Objects are shown as elongated shapes that extend across a horizontal direction. The horizontal elongation of these shapes allows summary information to be recorded within the shape—information such as the object's type or class, a reference label or name for the object, a textual comment and lists of the object's fields and methods.

### FIELD OF THE INVENTION

The present invention relates to software development and, more specifically to methods and apparatus related to diagramming a process such as a software process.

### BACKGROUND OF THE INVENTION

This invention delivers a new visual approach to creating and describing software designs in the complex area of software engineering. Why is a new approach to this needed? A brief look at the history of computer languages will make this clear. Consider this list of popular languages since the inception of computers: ADA, APL, Assembler, Basic, C, C++, C#, Cobol, Fortran, Java, Lisp, Pascal, Perl, PHP and Smalltalk. Obviously, the inventors of each of these languages must have felt a strong need to make software development easier to go through the trouble of creating and delivering each new language. And the fact that each language has a significant following proves that this need is felt not just by the language inventors, but the large population of programmers who use each of these; and most programmers have learned several languages—all in pursuit of an easier way to get the job done.

Yet looking back at this collection of languages, the progress in making software development easier has been modest—the fact is that most software development is still a complex undertaking no matter what language is used. Given the many diverse attempts at defining computer languages and the lack of correspondingly major leaps forward in making software development easier, it is time to look at why this so and to look into other directions to satisfy this universally felt desire for an easier way. The common denominator of all of these languages is that they define text based narratives—and to understand a narrative (such as this paragraph), one has to begin at the start and proceed linearly to the end without skipping any statement, word or element of punctuation. And the mental effort to understand a narrative is high. At any given point in a narrative, seemingly arbitrary facts from earlier in the text can be combined in unique and perhaps surprising ways, and to be able to understand what might be said at the current point, the reader needs to keep correctly in his mind all of the previous facts exposed. Furthermore, a given statement in a narrative may reference facts to come later, and so the reader needs to keep these forward references in mind as placeholders for filling in later when the subsequent information becomes clear—not an easy thing to do.

Narratives are therefore inherently difficult when used as the central artifact for software development. The alternative approach that will be taken here puts the description of software into a two dimensional diagram—so that a developer can see the software under consideration rather than read the software. However not just any two-dimensional exposition of software will do. Consider traditional flow charts—understanding these is just as difficult as understanding a narrative—one has to begin at the start and proceed linearly until the end, all the while keeping all the salient facts in mind to be able to understand the current statement under consideration—thus there is no significant extra value in this approach. To be truly valuable, a diagrammatic framework needs to provide a different approach to understanding. Thus the goal of a worthwhile diagrammatic approach is that the understanding of what is going on can begin at different starting points, and proceed along orthogonal lines to build up the full picture of what is going on—all the while still delivering the complete overall description of the functionality under development.

The FPS approach will deliver this on this vision, which will be introduced momentarily. FPS stands for a Floor Plan for Software; this name was chosen based on a metaphor for residential house construction. If you were to describe a dream house with a linear narrative (e.g. upon entering a 36 inch wide front door, if you would turn 90 degrees left, you would proceed for 18 inches and come to a wall, at that wall you would turn 90 degrees to the right and proceed 48 inches to a doorway etc.) and were to use this as the sole artifact to guide the construction of the house, the result would almost certainly be characterized by: missed deadlines, a product that doesn't live up to expectations and a steady stream of patches to correct errors. However by switching to a two dimensional floor plan to describe the house, communication and understanding is vastly improved amongst: yourself as the homeowner, the architect and the contracting team—resulting in a better end product. A floor plan format provides a richer way of digging into the desired design—one that permits multiple starting points for understanding that can also proceed across orthogonal lines. One can step back and look at the overall layout, or one can select any given aspect, the kitchen for instance, and zoom into this for further examination. A fireman can look at stairways and exits. A homeowner that suffers from the winter blues can examine the size and locations of all the south facing windows. A framer can develop a bill of materials for lumber and a mason can do the same for brick and mortar. When considering a particular room and the adjustment of its walls, we can easily see the cross impacts with adjoining rooms and tune out the impacts on distant rooms that are not involved. Finally, a floor plan has standard notations for walls, windows, doors, stairs, plumbing fixtures, appliances and more to bring out the key features of the design. The FPS approach will deliver this type of richness of approach to describing software.

One problem with UML (the Unified Modeling Language) is that it does not deliver the above described attributes needed for a good understanding of a software system. UML describes software using over a dozen different architectural views—so when considering any given view, the reader needs to keep in mind a dozen different views to truly understand operations being described at a given point. Also, UML does not provide notations to deal with aspects incredibly common to most software developments, aspects such as: arrays, hashes, files, directories and their operations, exceptions, events and the control structures to process these as well as databases, XML structures and other advanced constructs common to so many development efforts. The FPS approach will deliver this and more—all while using a single architectural view.

### SUMMARY OF THE INVENTION

The present invention delivers on the requirements above by providing methods, interfaces and devices for specifying a software process in a two dimensional diagrammatic framework. The major elements of this framework are software objects, operations on these objects, data flow and interaction operations between these objects, parameter specifications and a control flow context for these operations (samples of how these are represented in diagrams are shown in FIG. 1—which shows how a process can be specified that counts and sums the numbers within a file and writes the average to the system console). Objects are shown as elongated shapes that extend across a horizontal direction. The horizontal elongation of these shapes allows summary information to be recorded within the shape—information such as the object's type or class, a reference label or name for the object, a textual comment and lists of the object's fields and methods. Different, and possibly interacting objects are generally spaced from each other vertically in the diagram. The elongated shape of the software object also permits a sequence of more compact shapes to be positioned up against the object, where each compact shape will represent an operation on the object. Different shapes will signify different operation types—a shape that points away from an object will represent an operation that takes a value from the object without modifying it, while a shape that points towards an object represents an operation that modifies the object in some way. Mnemonic symbols within these compact shapes act to further specify the operation on the object. A label next to the compact shape may be used to further specify the field or method involved in the operation. A number of predetermined mnemonics are defined to represent operations common amongst programming projects. Lines may connect these compact shapes to represent data flow or interactions between objects via the operations connected. These lines pass “behind” the elongated objects. Parameters that further specify the operations can be included in text boxes that are connected to these operations with vertical lines. Finally, at the bottom extent of the vertical direction are a series of connected segments that define the control flow context for the operations—where flow generally proceeds from left to right. Each control flow segment effectively defines a vertical column or strip of operations that is to occur within that control flow segment. Different shapes and connections of control flow segments are used to represent loops, conditional branches and the like. Certain segment types are connected to object operations to indicate which object conditions control loops and branches and more. Predetermined control flow segment shapes are defined to represent common control flow constructs for loops and branches, exceptions and try-catch segments, real time operations such as wait and join states and more.

As stated earlier, the advantages of the methodology come from examining the software from multiple starting points and proceeding across orthogonal lines. When examining a figure, a reader can start with a high level understanding of the objects by reading across their descriptions within the elongated shapes. An understanding of control flow can proceed across the control flow segments to ensure that control flow is correct and understood. The detailed evolution of an object can be understood by looking at operations that modify the object, and tuning out operations that merely take values. And interactions between objects can also be easily isolated from other parts of the picture. The operation symbols and mnemonics also permit a high level understanding of the algorithm without bogging down in details.

When looking back at software written in a standard language as a narrative, as the reader moves from line to line, he would have to track in his head the understanding of each object—as associated with just its name or label, the state evolution of each, the interactions between objects and the overall control flow and its correctness and dependencies on object states. This requires a lot of mental juggling—and becomes incredibly difficult with more complex algorithms—a great recipe for making mistakes. With the FPS approach, this mental juggling is not required and many different paths of understanding can be pursued without the constant rereading of a narrative and with a much lower probability of making errors. The correctness of the software can be examined across these lines all the while keeping the overall function right in front of the developer. This is an undeniable advantage over text based narratives and is expected to become a commonly used tool in software development.

In a first embodiment, the present invention provides a method of illustrating a process, the method comprising:
representing objects as elongated shapes each containing at least one descriptor to specify an object being represented;
representing operations on or between objects as compact predetermined shapes, each predetermined shape being adjacent an elongated shape, each predetermined shape containing at least one symbol indicative of a specific operation being represented;
representing a control flow of said process through a connected series of possibly different control segments shapes which form a timeline, said timeline being parallel to the direction of elongation of an object shape such that a sequence of operations executed on or between objects is specified, wherein
said elongated shapes are spaced apart from one another (if more than one);
said predetermined compact shapes are adjacent elongated shapes representing objects upon which operations represented by said predetermined shapes are executed;
said predetermined compact shapes are connected by lines to elongated shapes representing objects from which operations represented by said predetermined shapes are executed;
different predetermined compact shapes are use to represent operations which modify an object and operations which do not modify an object;
said control segment shapes each define an elongated strip perpendicular to the timeline;
each of said predetermined compact shapes being located in a strip and each section of said timeline being located in a strip such that said operations represented by said predetermined compact shapes in a strip are executed according to said flow control mechanisms represented by said timeline segment located in said strip;
each strip contains a portion of at least one of said elongated shapes such that for each strip it is illustrated that operations on or by said object represented by said at least one elongated shapes are represented by predetermined compact shapes located in said strip and said operations are to be executed according to control mechanisms represented by said timeline segment in said strip.

In a second embodiment, the present invention provides a user interface for use in navigating a computer aided design software package, the user interface comprising:
a first set of activatable on-screen buttons (or other use activated controls such as name or menu controls), each one of said first set representing a predetermined compact shape representing an operation on or between objects;
a second set of activatable on-screen buttons (or other controls), each one of said second set representing a segment shape representing a flow control mechanism;
at least one activatable on-screen button (or other control) representing an elongated shape representing an object; wherein
there is a grid (possibly visible) for the placement of different shapes to form a diagram;
and upon activating a control for a shape the user may use a mouse or other mechanism to initially place the selected shape within the grid, and where necessary, a dialog box is presented to the user, to use a keyboard or other controls to enter or select information to complete the information associated with such shape such as: labels, comments, field names, method names etc. to finalize said shape's representation on the screen.

In a third embodiment the present invention provides a computer readable media having encoded thereon computer readable code for implementing a method of illustrating a process, the method comprising:
representing objects as elongated shapes each containing at least one description specifying an object being represented;
representing operations on or between objects as predetermined compact shapes, each predetermined shape being adjacent an elongated shape, each predetermined shape containing at least one symbol indicative of a specific operation being represented;
representing a control flow of said process as a connected series of control segment shapes forming a timeline, said timeline being parallel to the direction of elongation of an object shape such that a sequence of operations executed on or between objects is specified;
   wherein
said elongated shapes are spaced apart from one another (if more than one);
said predetermined compact shapes are adjacent elongated shapes representing objects upon which operations represented by said predetermined shapes are executed;
said predetermined compact shapes are connected by lines to elongated shapes representing objects from which operations represented by said predetermined shapes are executed;
different predetermined compact shapes are use to represent operations which modify an object and operations which do not modify an object;
said control segment shapes each define an elongated strip perpendicular to the timeline;
each of said predetermined compact shapes being located in a strip and each section of said timeline being located in a strip such that said operations represented by said predetermined compact shapes in a strip are executed according to said flow control mechanisms represented by said timeline segment located in said strip;
each strip contains a portion of at least one of said elongated shapes such that for each strip it is illustrated that operations on or by said object represented by said at least one elongated shapes are represented by predetermined compact shapes located in said strip and said operations are to be executed according to control mechanisms represented by said timeline segment in said strip.

### BRIEF DESCRIPTION OF THE DRAWINGS

A better understanding of the invention will be obtained by considering the detailed description below, with reference to the following drawings in which:

FIG. 1 is a sample of a diagramming method according to the invention illustrating the different types of shapes and symbols for representing objects, operations, and control flow mechanisms;

FIG. 2 is a further sample of the diagramming method illustrated in FIG. 1 showing additional control flow structures;

FIG. 3 is a sample of the diagramming method according to the invention illustrating how exception handling and catch and try control flow mechanisms are treated;

FIG. 4 is a sample of the diagramming method according to the invention illustrating how calculation boxes, references and method signatures are specified;

FIG. 5 is a sample of the diagramming method according to the invention illustrating how multithreaded processes are illustrated and how threads may be joined;

FIG. 6 is a sample of the diagramming method according to the invention illustrating how relationships between different objects such as database objects are represented;

FIG. 7 illustrates a user interface for a CAD tool which implements the method of the invention.

### DETAILED DESCRIPTION

A unified view is presented with objects being represented by an elongated shape with fields containing identifiers and descriptors of the object represented. The elongated shapes are generally arranged in a column with the column being divided into subcolumns or strips. Operations on or between objects are represented by predetermined shapes with each predetermined shape containing a symbol representative for the operation. At the bottom of the view is a control flow representation of the process, shown as a timeline. The timeline is illustrated with lines and specific control segment shapes to denote control flow mechanisms such as loops, conditional branches, and the like. Each section of the timeline is located in a subcolumn or strip and any operations to be executed during that section of the timeline are represented by locating predetermined shapes in the same strip occupied by the timeline segment.

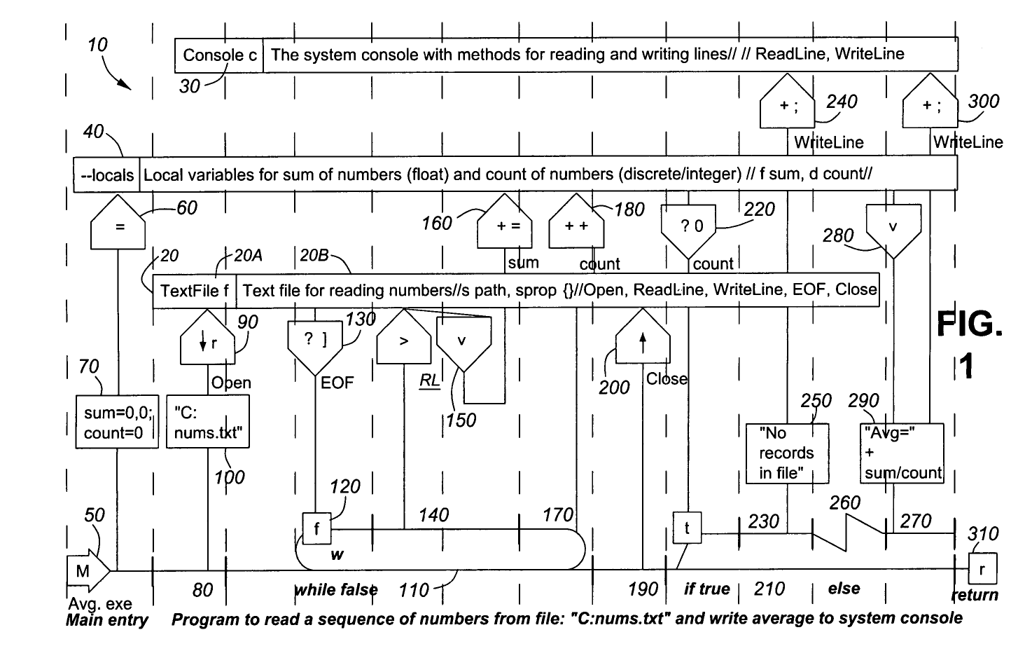

Referring to FIG. 1, an example of the diagramming method is illustrated generally as 10. This diagram represents a program for reading a list of numbers from a file, summing and counting these numbers, and writing the average to the system console. As would be expected, such a program would involve such objects as: the file to be read 20, the system console 30 and a couple of local variables to represent the sum and count of the numbers—which are included under (an informal) object 40. The elongated object shape 20 uses two fields to describe the role and details of the object—field 20A gives the class name (“TextFile”) and its specific reference label (“f”). The field 40B contains a textual description of the object, a list of the objects fields (a string to represent the file's path in the system and a hash of strings to contain the file's properties) and a list of methods, in this case: “Open”, “ReadLine”, “WriteLine”, “EOF” and “Close”. These details are separated by double slashes “//”. The console object “c” 30 has just two methods and no fields and the informal object “locals” has just two fields: one for a floating point variable sum and another for a discrete (integer) variable “count”. The fact that object 40 is informal is indicated by the double dash “—” as the class/object type.

The algorithm's control flow starts at control flow segment 50, where this symbol signifies the main entry point of the program “Avg.exe”. This first segment of the program causes an assignment operation on informal object 40. This is signified by the compact shape 60 which is butted up against the object 40, where the equals symbol “=” is a mnemonic for assignment. The text box 70 provides the details of the assignment operation, in this case both variables of object 40 are set to zero. The fact that the compact shape 60 points towards object 40 means that the object 40 is being modified in some way.

The next control flow segment 80 which connects to and follows segment 50, causes an “Open” operation on file object 20. The compact shape 90 points towards the object meaning that the state of the object will be changed, and in this case the symbol “<down arrow>r” means open the file for reading. Up and down arrows are mnemonics for dealing with hierarchical collections—a down arrow means move into a lower level—an up arrow means move up out of a level. Moving into a file is the same as opening it—in this case for reading signified by the “r” mnemonic. The label “Open” next to this symbol is redundant, but helpful in recognizing that this is the “Open” method that is being invoked. The text box 100 contains the name of the file to be opened—which is a parameter needed by the “Open” method if the “path” string of the object has not already been set.

The control flow segment 110 follows segment 80; this segment represents a while loop, which contains a number of nested segments. That this is a while loop is indicated by the oval shape with the “w” symbol within the left part of the shape. This while loop proceeds while a condition is false—as indicated by the “f” in the box at the start of the loop 120. In this case the method “EOF” (end of file) is invoked on the file object 20 to see if the end of the file has been reached, and if true then control moves to segment 190 which is outside the loop. Otherwise segments 140 and 170 within the loop will follow. The compact shape 130 for “EOF” points away from the object 20 to signify hat it takes a value or result from the object without modifying the object. The mnemonic “?]” comes from “?” meant to indicate checking a condition and “]”, which comes from a series of operations on arrays (or collections), indicated by square brackets “[ ]”, where a closing bracket “]” represents the end of an array. So “?]” checks to see if the current pointer of a collection has reached the end of a collection—in this case a file which is a collection of text lines. The fact that the label “EOF” is next to this compact shape is a helpful redundancy.

The first loop segment after the while condition is checked is segment 140 which causes a line to be read and the number returned to be added to the “sum” local variable. The “ReadLine” method of the file is one where the file is altered by moving across a line, signified by the “>” move across mnemonic within a modify compact shape combined with the take value operation signified by take value compact shape with a “v” mnemonic. This combination is shown as 150. The underlined “RL” label is a redundancy to note that the “ReadLine” method is being invoked. An underlined label is a short form for a longer label where only the first letter and subsequent capitals are included in the short form. Also within the column defined by segment 140, the value obtained from the “ReadLine” method is added into the local variable “sum” as signified by operation 160. The mnemonic “+=” is taken from the computer languages C++, Java etc. which means to add a number into another—the “sum” label is necessary to indicate that the operation acts on this variable of the informal object 40. The control flow segment 170 causes the local variable count to be incremented by 1. This is indicated with compact shape 180, where the mnemonic “++” is again taken from the C++ and Java languages which mean to increment a variable by one. The “count” label is necessary to indicate that this operation acts on the corresponding variable. These segments 140 and 170 will be repeated until the end of the file is reached.

Once control moves out of the loop 110, segment 190 is reached which sees the file being “Closed” 200. The mnemonic <up arrow> means to move out of a collection, in this case closing the file. The “Close” label is redundant. Control flow segment 210 represents the start of an “if” block with nested segments 230, 260 and 270. To determine if the segment 230 is entered, the operation 220 is taken on the count variable of object 40. If the count is zero, represented by the mnemonic “?0”, then control segment 230 is entered. If “count” is zero, then no records have been read and an average cannot be computed. Thus operation 240 writes a line to the system console—where the line is contained within text box 250 indicating that no records have been read. If segment 230 is not entered, then segment 260 (“else”) indicates that segment 270 should be entered instead. In this case, operation 280 takes values from object 40, and these are specified and used in the text box 290 to form an output string built up of a string and the computed average, to be written to the system console as operation 300. The “WriteLine” mnemonic is “+;” which comes from append “+” and end of line “;”. The “WriteLine” label is redundant. Finally, segment 310 is entered which signifies a “return” from the algorithm. Diagram text in italics are comments.

It should be noted that while compact shapes 90, 60, 130 and others, are used in FIG. 1, other predetermined shapes may be used to denote operations which retrieve data or parameters without affecting the objects. Similar predetermined shapes may be used to represent operations which affect the objects.

It should further be noted that segments 80, 110, 190, 210, 310 taken together form a timeline that illustrates the sequence in which operations are executed. The timeline is, as shown in FIG. 1, divided into subcolumns or strips with each subcolumn containing the predetermined shapes that represent operations to be executed in that time segment. The timeline also includes the various shapes and lines in FIG. 1 including the oval shape for loops and the diverging lines in segments 210, 260 to represent conditional branches. As can be seen in FIG. 1, the division of the timeline into subcolumns or strips is quite convenient as each segment corresponds to at least one subcolumn or strip.

As can be seen from FIG. 1, each one of the predetermined shapes 60, 90, 130, 150, 180, 200 and others all have symbols which denote the operation being performed. The predetermined shape can be any shape but it is preferable that the shape have a vertex so that the vertex can be pointed at the object that is being modified or pointed away from the object that is not being modified.

The symbols inside the predetermined shape can take many forms and definitions. The following are examples of the possible symbols and their definitions. It should be noted that the following examples are divided into two categories—one for operations which merely retrieve or take a value from an object without affecting the object's values and another for operations which set or modifies an object's value. Thus, operations which do not affect an object's value are under the “Take Value” shapes column while operations which set or modify an object's value are under the “Set Value” shapes column.

Predefined Symbols for Defining Object Types

Collections

[ ]—as appended to a label (or name) means an array
[s]—as appended to a label means a stack
[q]—as appended to a label means a queue
{ }—as appended to a label means a hash
[/]—as appended to a label means an ordered collection by ascending values
[\]—as appended to a label means an ordered collection by descending values
{/}—as appended to a label means a hash ordered by ascending keys
{\}—as appended to a label means a hash ordered by descending keys
   Primitive Types
b—preceding a field name means a Boolean variable
c—preceding a field name means a character variable
d—preceding a field name means a discrete (or integer) variable
e—preceding a field name means an enumeration or variable representing a discrete state
f—preceding a field name means a floating point variable
i—preceding a field name means an index (non-negative integer) referring to a point in a collection
k—preceding a field name means an alphanumeric to represent the key of a hash or table collection
o—a top level object (any object type can be cast into this object)
r—preceding a field name means an alphanumeric to represent an index or key in a related hash or table
s—preceding a field name means a string variable (a collection of characters)
q—preceding a field name means a table that is the result of a query on a database
t—preceding a field name means a database table
x—an XML fragment which may be a whole XML document or just part of one
   Predefined Mnemonics for Operations on General Object Types
   Take Value Shapes
v—take value
?x—is null
( )—take a cast to fit into a different type (e.g. discrete to float)
c—take a copy of an object
f—format a value using a parameter (parameter supplied by another operation or text box)
   Set Value Shapes
=—set value as result of other operation or list box
=0—set to default or clear state
=x—set to null
˜—perform computation (waveform mnemonic)
<bullet>—(possible) change of a discrete state
   Predefined Mnemonics for Operations on Boolean Variables
   Take Value Shapes
?—is true?
?f—is false?
   Set Value Shapes
=t—set to true
=f—set to false
=—set as result of other operation (or list box)
+=—or
*=—and
x=—xor
n=—nand
−=—invert
   Predetermined Mnemonics for Operations on Enumerations
   Take Value Shapes
<bullet>—take state (bullet meant to bring to mind a radio box control in a web form)
?x—is empty or default state
   Set Value Shapes
<bullet>—set state
=—set state as result of other operation (or list box)
   Predetermined Mnemonics for Operations on Floats, Discrete Variables and Indexes
   Take Value Shapes
v—take value
?0—is zero
?1—is one
?+—is positive or zero
?−—is less than zero
   Set Value Shapes
+=—add to
−=—subtract from
/=—divide into
*=—multiply by
++—increment by 1
−−—decrements by one
=0—set to zero or clear
=1—set to 1
=—set value as result of other operation (or list box)
   Predetermined mnemonics for operations on strings (a string is also a collection of characters, so the collections operations on the characters can also be performed if the string is first opened or cast to a character array).
   Take Value Shapes
s—take string
?x—is null or empty
   Set Value Shapes
+—append to
%—make substitution (or perform regular expression contained within text box)
=—set value
=x—make null or empty
   Predetermined mnemonics for Operations on Queues
   Take Value Shapes
v—take value of item in head of queue (last in, first out)
n—count of items in queue
?0—is queue empty
   Set Value Shapes
+—insert into queue (into back of queue)
−—remove from queue (from front)
=x—clear all or empty the queue
   Predetermined Mnemonics for Operations on Stacks
   Take Value Shapes
v—take value of item at top of stack
n—count of items in stack
?0—is empty
   Set Value Shapes
+—push onto top of stack
−—pop off top of stack
=x—clear all or empty the stock
   Predetermined Mnemonics for Operations on Collections (Arrays, Hashes, Directories, Files, XML Documents etc.)
   Move Into and Out of Level
   Set Value Shapes
<down arrow>—move down into level
<up arrow>—move up one level
   Take Value Shapes
?<up arrow>—can move up (false if at top level)
?<down arrow>—can move down (true if not a leaf node)
   Move Within a Level
   Set Value Shapes
[—move to start of collection
]—move to end of collection
>—move across one item
<—move back one item
i—move to index
   Take Value Shapes
?]—at end of collection
?[—at start of collection
i—take current index point
   Inserting and Deleting Items
   Set Value Shapes
]+—append to end of collection
+[—insert at start of collection
−[—remove first item of collection
−]—remove last item of collection
+i—insert before current index position
i+—insert after current index position
−i—remove item before current index position
i−—remove item after current index position
+/—insert in ascending order
+\—insert in descending order
[n—truncate to size keeping first items
n]—truncate to size keeping last items
   Take Value Shapes
n—number of items in collection
   Ordering of Collection
   Set Value Shapes
o/—put into ascending order
o\—put into descending order
   Searching Collection
   Set Value Shapes
s>—search forward to meet criteria (contained in text box as parameters)
s<—search backwards to meet criteria
   Operations for shared collections—such as directories which may have properties changed by other threads or processes by methods such as: adding, deleting or changing files in the directory
   Take Value Shapes
?i—has item at current index changed
?o—has the order of the collection changed
?n—has the number of items changed
?[ ]—has the overall collection changed in any way
   Operations on Hashes
   Set Value Shapes
+—insert into hash
−—remove item
=—overwrite current item
{ }—move to item based on provided key (either a text box or result of another operation)
   Take Value Shapes
n—number of items in hash
?k—does hash key exist as specified in parameter (such as text box)
v—take value of current item
k—take key of current item
   Operations on Databases
   Set Value Shapes
<down arrow>—open/move into
<up arrow>—close/move out of
(—commit changes
)—roll back changes
   Operations on XML documents or fragments (in addition to collections operations)
   Set Value Shapes
< >—insert tag pair with contents
+—insert a string
%—substitute next occurrence
\hat{ }—skip over any text (until next tag)
<?>—move to tag with specified ID
   Take Value Shapes
t—last text if any
x—last XML fragment if any
< >—contents of current tag pair (if any)
<n—take most recent tag name read
<k—take tag property keys as array of strings
<V—take tag property value for specified property name (key provided as parameter)
   Composite Set and Take Value Shapes
&- and k—move to next escape sequence (&-name;) and return the escape text key (“name”)

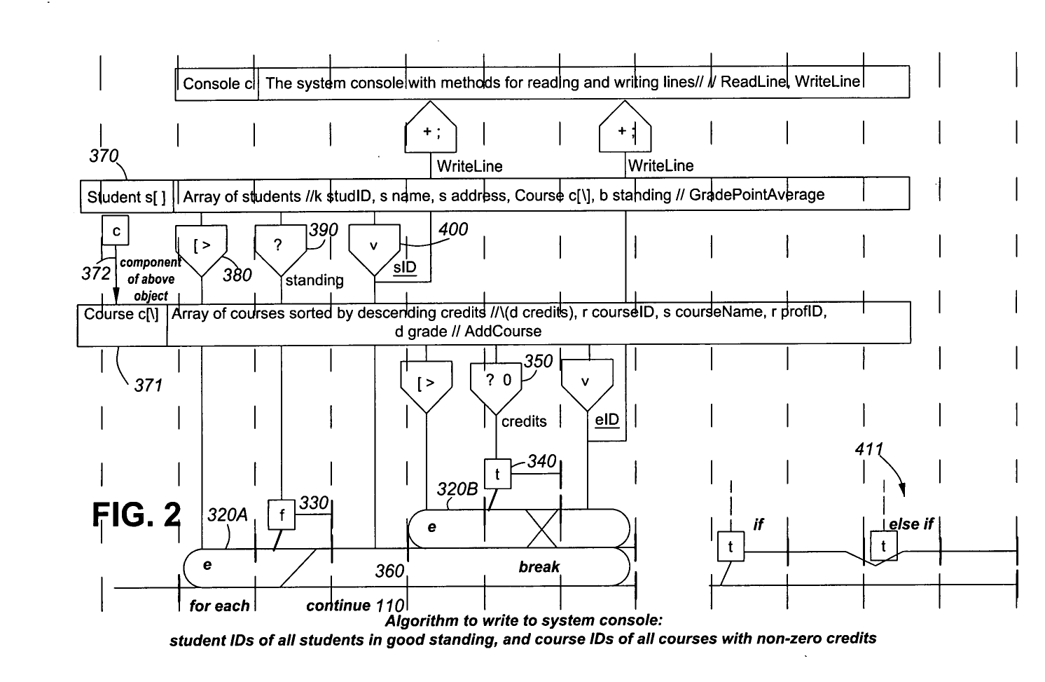

As noted above, control flow mechanisms can be represented by shapes and/or lines. A for-each loop can be used using the control flow mechanism illustrated in FIG. 1, but with an ‘e’ instead of the ‘w’ in the first half circle that denotes the beginning of the loop. Conditional branchings can be done with the illustrations used in FIG. 1 but for more elaborate and complex structures, the representations in FIG. 2 can be used.

FIG. 2 illustrates some more possible control flow representations, including the nesting of loops and the interruption of normal loop processing via continue and break control flow structures. Object 370 represents an array of student records. Within a given record is another array of courses that the student has taken. This array of courses is brought out in object 371, which is indicated by the “component” notation 372. This component relationship between objects shapes is independent of timeline. This same notation can be used to represent inheritance between objects by using an “i” mnemonic instead of “c”. The left part of the diagram (with the nested loops) loops over each student record and further lops over each course of each student to write information to the system console. The operation 380 at the start of the for each loop 320A, moves to the start of the student array 370, and thereafter moves across one student record for each loop pass until all the records have been treated. Hence the mnemonic “[>” which signifies move to start then read across one. In this algorithm, we will skip pass students not in good standing, hence if the result of operation 390 is false, then the remainder of the loop 320A is skipped and control moves (“continues”) to the start and the next student record is accessed. This is shown by the continue indicator 360. If the student is in good standing then the loop operations proceed, and the student ID is written to the system console. Then another for each loop 320B is entered to access each course within a student record. These course records 371 are ordered in descending order of credits. This algorithm will not write course Ids for non-credit courses to the system console. So as long as the course credit is non-zero, operations will proceed past segment 340 and the course IDs will be written to the system console. Once a course is found to have zero credits by operation 340, then loop 320B is broken out of and control moves back to loop 320A. This break is indicative with the symbol 341 within loop 320B.

The nested loops 320A, 320B are shown as being nested by having their respective shapes on top of one another. Loop 320B, by virtue of being at the top, is the loop nested within the first loop 320A. Besides these loop structures, and the conditional structures shown previously, this figure also shows how an else-if segment can be added to a conditional segment as shown by control segment 411.

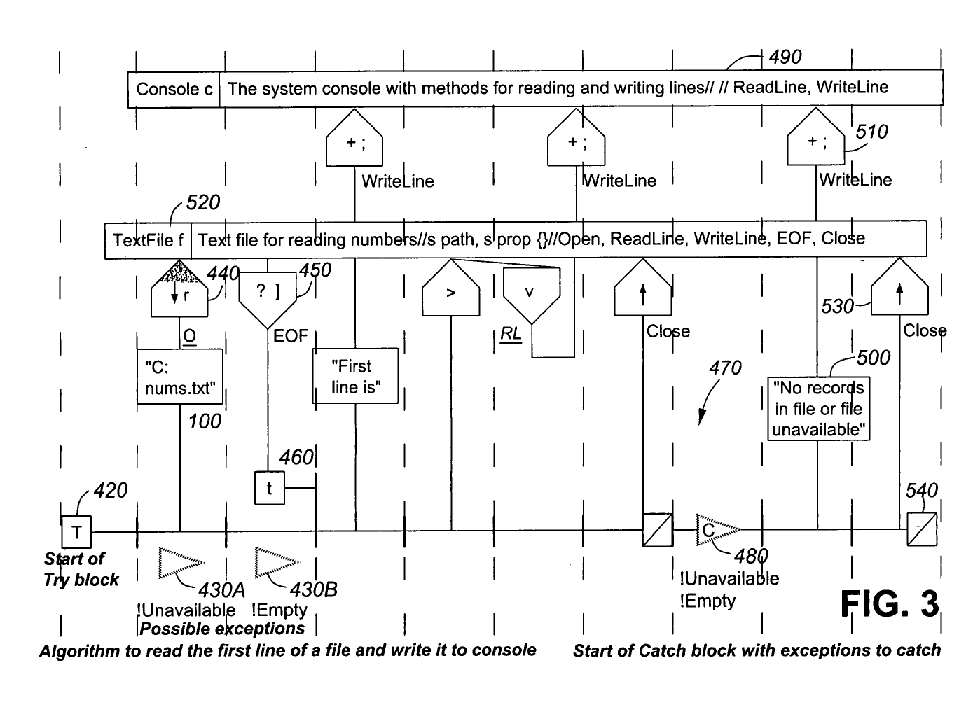

FIG. 3 illustrates how exceptions and catch blocks can be handled using the methodology outlined above. The start of a try block is denoted by the symbol 420. The exception shapes 430A, 430B indicate possible exceptions that may occur due to operations such as operations 440, 450. Operation 440 tries to open a file and if the file is not available, then an exception is generated. That this operation may cause an exception is indicated by the shading within the operation shape. Similarly, operation 450 checks if an EOF (end of file) has been reached and if this condition is true (see conditional branch 460), then another exception is explicitly generated as a result of the condition.

Once the exceptions have been generated, the catch block 470 catches the exceptions and the exceptions handling procedures are executed. For catch block 470 (denoted by catch shape 480) the exception handling procedures consist of writing a specific line of text to the console object 490. This is shown by text box 500 and operation 510. Once this text is written to the object, the file 520 is closed (see operation 530) and the catch block is terminated (symbol 540). Control segment symbol 540 is the same type that is used to indicate the closing of the try block.

It should be noted that, for ease of reference, the conditions which cause exceptions and the conditions which a catch block are supposed to catch, are labelled and listed below the main timeline. It is possible that different catch blocks can be shown to treat different exceptions.

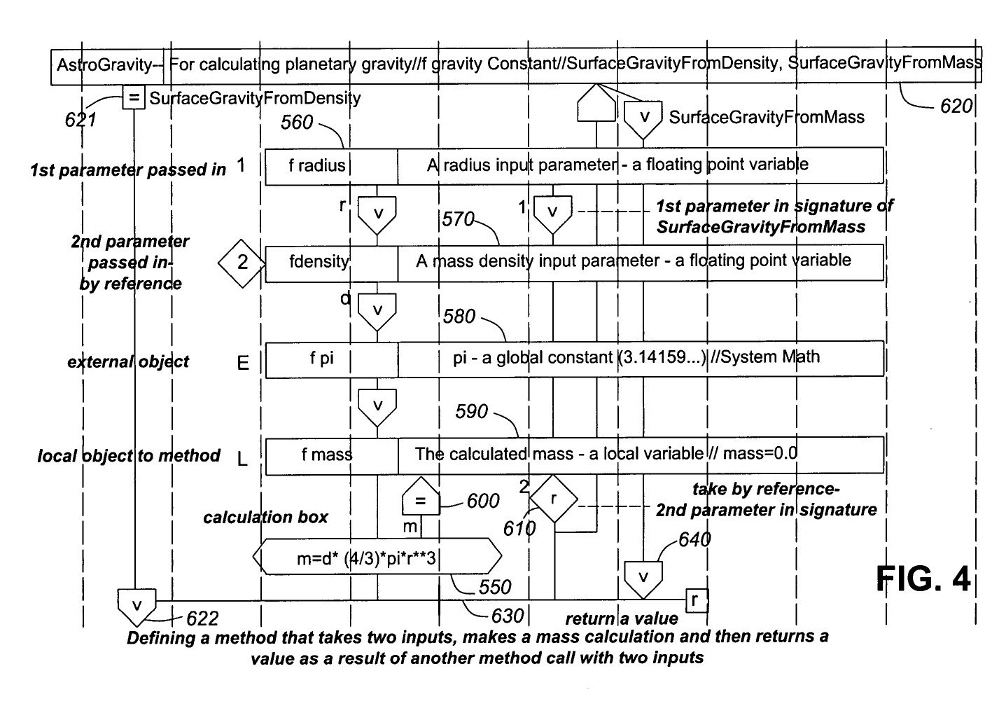

While FIGS. 1 and 3 featured some types of boxes for text and/or assignments, other boxes may be used for other purposes. Referring to FIG. 4, a calculation box 550 is used to denote a calculation which returns a value as a result of a computation or its inputs. FIG. 4 also shows how method signatures are specified and take by reference is indicated.

FIG. 4 is concerned with specifying a method “SurfaceGravityFromDensity” as part of an “AstroGravity” class 620. That the diagram is defining this method is indicated by the connector symbols 621 and 622, where symbol 622 shows the mnemonic symbol for this method when used (as opposed to being defined) in another diagram. The mnemonic ‘v’ means that the method returns a value without affecting the object. This method takes two inputs, the first is radius 560 and the second is density 570. The order of these parameters is shown by the numbers to the left of the objects. That the second parameter is passed in by reference is indicated by the diamond shape to the left. The method also uses two other objects, pi 580 and mass 590. That pi is an external (or global) object is indicated by an E to the left, and that mass is a local object is indicated by an L to the left. This information is useful to specify software when code is to be written. The first step of the method shown is to calculate the mass variable 590 from the parameters and other inputs. This is done in the calculation box 550, where the mass is stored using operation 600. The calculation box 550 uses inputs from radius 560, density 570 and pi 590. Within the calculation box 550, radius is aliased as “r”, as indicated by the notation to the left of the get value operation, and density 570 is aliased as “d” shown to the left of the get value operation. The result of the calculation is “m” which is the line labelled leaving the calculation box to assign to the mass object 600. The “pi” object 580 is not aliased—its object label is used without change in the calculation box 550.

The next step in the method 630 passes radius (first) and mass (second) by reference as parameters to the method “SurfaceGravityFromMass” which returns a value. The order of these parameters is determined by numbers to the left of the operations that take these parameters. A diamond shape indicates that mass 590 is taken by reference 610. The ‘v’ symbol 640 in the return segment 630 means the method returns a value.

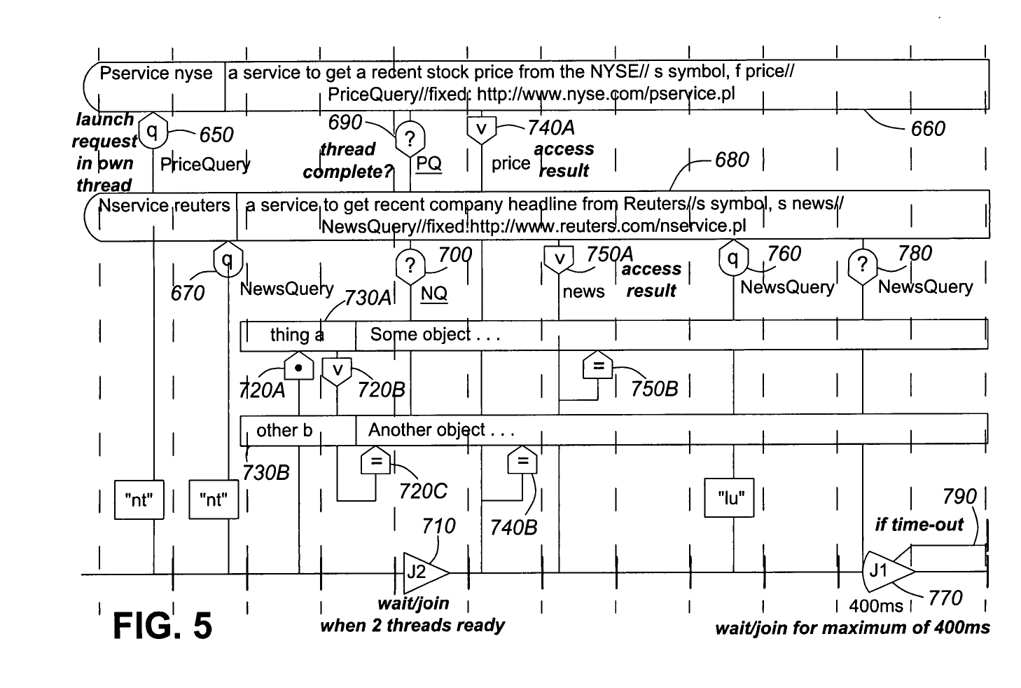

Referring to FIG. 5, multithreaded operations may be represented as shown in the figure. Objects 660 and 680 have methods that can run in their own threads, this is indicated by the rounded edges on the left of these objects. The method “PriceQuery” within object 660 runs in its own thread, and operation 650 indicates this by the rounded bottom edge of the operation shape. The ‘q’ mnemonic is for launching a web query. Similarly, the “NewsQuery” method of object 680 is represented by operation symbol 670. While these two threads have been launched, the figure shows that other operations can proceed on objects “a” and “b”. Control segment 710 represents a wait state to join two threads thus the mnemonic “J2”. The two threads to join are in objects 660 and 680 as shown by operations 690 and 700. Operations 690 and 700 indicate whether the previously launched methods have completed, and if both have, control flow moves past 710. Once past this wait/join state, the algorithm can access other aspects of the objects involved. Operation 760 launches another thread. The join state 770 is slightly different this time. The rounded left edge of the triangle and mnemonic “J1” indicate that this state will wait for one thread, in this case from object 680, as driven by query operation 780, but only for maximum time of 400 ms. If the thread has not completed by 400 ms, then control segment 790 is entered and other operations can apply. If the thread does complete before the 400 ms timer, then control moves past segment 770 for other possible operations. Round shapes are mnemonic for clocks, and used here to indicate objects, operations and control flow symbols using time or threads.

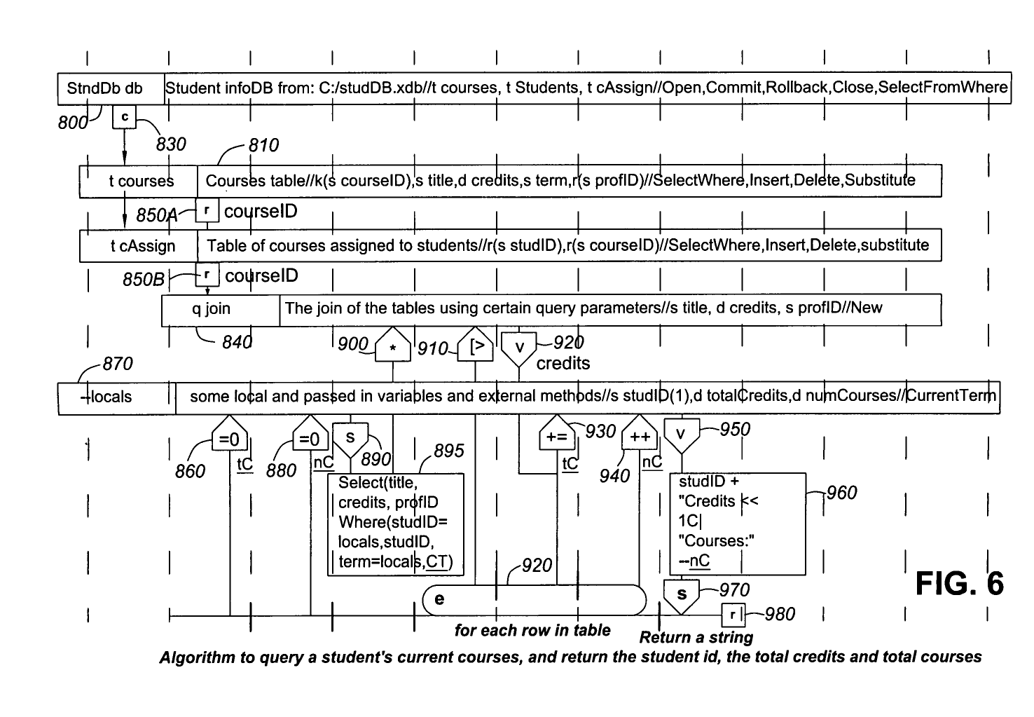

Relationships between different types of objects may also be illustrated using the above method. Referring to FIG. 6, the relationships between the database object 800 and component objects 810, 820 are shown by the symbol 830. Objects 810, 820 are component tables of the database object 800.

That these two tables 810 and 820 can be related in a way to form a new, joined table 840 is indicated by relationship symbols 850A and 850B which connect to query table 840. The field that these two tables use to join their contents is “courselID” as indicated by the labels next to relationship indicators 850A and 850B. The algorithm in this figure queries a student's current courses in the database and returns the student ID, his total course credits and total number of courses. Object 870 is an informal one which contains a string of the student ID passed in as a first parameter, a count of the total credits and a count of the total courses. There is also an informal method “CurrentTerm” to return the value of the current term at school (e.g. as a string “Winter 2004”). The algorithm begins with operations 860 and 880 which set “TotalCredits” and “numCourses” to zero. The next step initializes or creates 900 the table “join” according to a query specification contained in the text box 895. The query specification 895 uses the string “StudID” and the string result of “CurrentTerm” as linked in by operation 890. The query specification follows the standard SQL syntax of Select-From-Where, except that the “From” portion can be omitted as it is already specified as the join of tables 810 and 820 as indicated by 850A and 850B. Now the for-each loop can total the number of credits and courses from the table 840, keeping these totals in 870. Finally the courses and credits are inserted into a string within textbox 960, and this is returned as a result as part of 970 and 980.

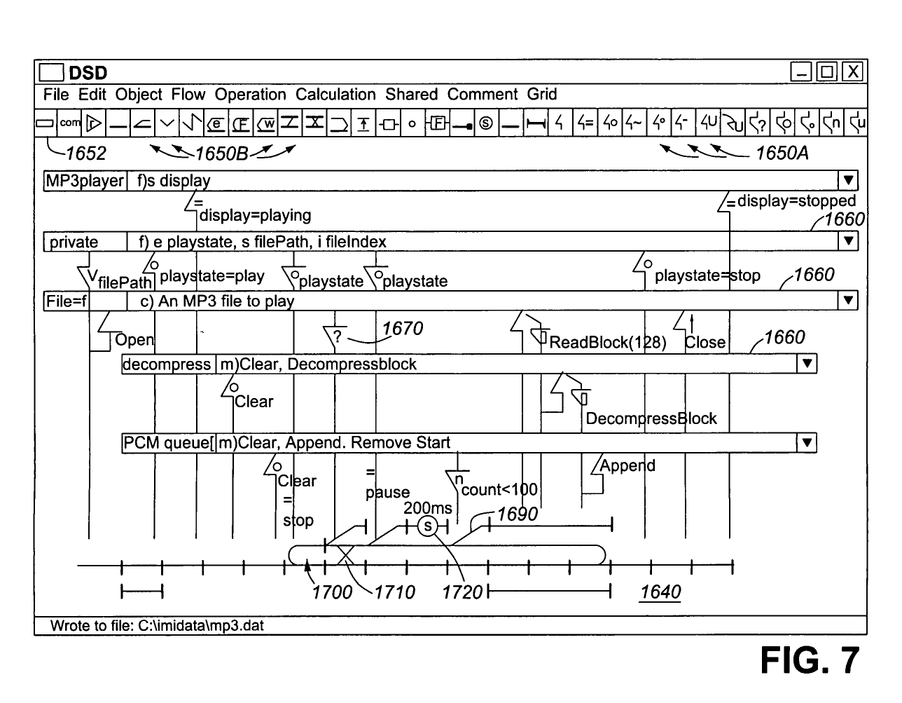

The above method can be implemented as a CAD (computer aided design) software tool. FIG. 7 illustrates a screen view of an actual CAD tool user interface which was designed to implement the above method. The interface has a gridded workspace 1640 upon which the different symbols, shapes, and representations can be placed. A user can do this by merely clicking on one of the icons from the icon bars 1650A, 1650B and then using the mouse to place the selected item on the screen. These icons represent the different symbols and representations described above and in the figures. For operations, icon bar 1650A contains the icons for the most commonly used icons while icon bar 1650B contains the icons for object creation and control flow structures. After the initial placement of an item on the screen, an associate dialog box is often used to input any parameter information to finalize the objects representation, such as specifying comments, fields, methods mnemonics and other labels.

The icon bar 1650A contains the shapes representing the operations with each shape containing the relevant symbol indicative of the operation being represented. Icon bar 1650B contains at least one icon (icon 1652A) that has a geometric shape for representing object creation. The rest of the icons in the icon bar 1650B contains the different representations for the different control mechanisms which may be used. Conditional branches, beginning and ending loops, conditional ends to loops, and other control flow mechanisms are represented for possible use by a user.

As can be seen from FIG. 7, each of the objects created on the workspace 1640 has a drop-down section 1660. The drop down section 1660 provides the user with the ability to selectively view comments, properties, or fields as required by the object without taking up too much of the visible workspace. The ready-made grid on the workspace allows for the proper placement of the relevant operations symbols in the proper section of the timeline.

It should be noted that the methodology explained above and the CAD tool described above allows for the placement of parameters relating to an operation beside the shape representing the operation. As an example, operation 1670 in FIG. 7 has the notation ‘EOF’ next to the query symbol/shape. This indicates that the query determines if the end of file (EOF) condition has been reached. Similarly, operation 1680, upon which conditional branch 1690 is dependent, returns a value and if the condition provided as a parameter (count<100) is met, then the branch is taken.

FIG. 7 also illustrates another control flow mechanism related to real-time processing. The control segment 1720 (a circle with an “s” inside it) is meant to represent a sleep timer, with the label above it specifying the sleep time (200 ms).

It should further be noted that the above methodology, while suitable for diagramming software processes such as software projects, may also be used for diagramming other processes. The CAD tool described above may also be used for diagramming processes other than software processes.

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A method of illustrating a process, the method comprising:
representing objects as elongated shapes each containing at least one descriptor to specify an object being represented;
representing operations on or between objects as compact predetermined shapes, each predetermined shape being adjacent an elongated shape, each predetermined shape containing at least one symbol indicative of a specific operation being represented;
representing a control flow of said process through a connected series of possibly different control segments shapes which form a timeline, said timeline being parallel to the direction of elongation of an object shape such that a sequence of operations executed on or between objects is specified,
wherein
said elongated shapes are spaced apart from one another (if more than one);
said predetermined compact shapes are adjacent elongated shapes representing objects upon which operations represented by said predetermined shapes are executed;
said predetermined compact shapes are connected by lines to elongated shapes representing objects from which operations represented by said predetermined shapes are executed;
different predetermined compact shapes are use to represent operations which modify an object and operations which do not modify an object;
said control segment shapes each define an elongated strip perpendicular to the timeline;
each of said predetermined compact shapes being located in a strip and each section of said timeline being located in a strip such that said operations represented by said predetermined compact shapes in a strip are executed according to said flow control mechanisms represented by said timeline segment located in said strip;
each strip contains a portion of at least one of said elongated shapes such that for each strip it is illustrated that operations on or by said object represented by said at least one elongated shapes are represented by predetermined compact shapes located in said strip and said operations are to be executed according to control mechanisms represented by said timeline segment in said strip.

2. A method according to claim 1 further including representing list assignments and parameter specifications as a separate shape containing details of said assignments and parameters.

3. A method according to claim 1 further including representing mathematical expressions as a separate shape, said shape containing said mathematical expressions.

4. A method according to claim 1 wherein said process is a real-time process, and with the method including unique shapes for objects, operations and control flow segments to distinguish the treatment of real-time aspects of the process.

5. A method according to claim 1 wherein said flow control mechanisms includes at least one mechanism selected from a group comprising:
looping;
conditional branching;
nested looping;
nested branching;
exception branching; and
the handling of threads.

6. A method according to claim 1 wherein notations are included for said objects and related operations can represent collections including:
an array;
a hash;
a database;
a table;
a file;
a queue;
a stack;
a tree structure; and
a software variable.

7. A method according to claim 1 further including representing relationships between objects as links between said objects, said links being independent of the timeline and having the ability to represent relationships such as components inheritance, definitions and database table relationships.

8. A method according to claim 1 wherein said operations includes operations selected from a group comprising:
sorting;
selecting;
parsing;
substitution;
formatting;
copying;
making assignments;
making state changes;
making computations; and
returning values.

9. A user interface for use in navigating a computer aided design software package, the user interface comprising:
a first set of activatable on-screen buttons (or other use activated controls such as name or menu controls), each one of said first set representing a predetermined compact shape representing an operation on or between objects;
a second set of activatable on-screen buttons (or other controls), each one of said second set representing a segment shape representing a flow control mechanism;
at least one activatable on-screen button (or other control) representing an elongated shape representing an object;
wherein
there is a grid (possibly visible) for the placement of different shapes to form a diagram;
and upon activating a control for a shape the user may use a mouse or other mechanism to initially place the selected shape within the grid, and where necessary, a dialog box is presented to the user, to use a keyboard or other controls to enter or select information to complete the information associated with such shape such as: labels, comments, field names, method names etc. to finalize said shape's representation on the screen.

10. A user interface according to claim 9 wherein said first set includes at least one predetermined shape representing an operation selected from a group comprising:
sorting;
selecting;
parsing;
substitution;
formatting;
copying;
making assignments;
making state changes;
making computations; and
returning values.

11. A user interface according to claim 9 wherein said second set includes at least one symbol representing a flow control mechanism selected from a group comprising
looping;
conditional branching;
nested looping;
nested branching;
exception branching; and
thread handling.

12. A user interface according to claim 9 where said objects and related operations can represent collections, including:
an array;
a hash;
a database;
a table;
a file;
a queue;
a stack; and
a tree structure.

13. A user interface according to claim 9 wherein list assignments and parameter specification are represented as a separate shape containing details of said assignments.

14. A user interface according to claim 9 wherein mathematical expressions are represented as a separate shape, said shape containing said mathematical expressions.

15. A computer readable media having encoded thereon computer readable code for implementing a method of illustrating a process, the method comprising:
representing objects as elongated shapes each containing at least one description specifying an object being represented;
representing operations on or between objects as predetermined compact shapes, each predetermined shape being adjacent an elongated shape, each predetermined shape containing at least one symbol indicative of a specific operation being represented;
representing a control flow of said process as a connected series of control segment shapes forming a timeline, said timeline being parallel to the direction of elongation of an object shape such that a sequence of operations executed on or between objects is specified;
wherein
said elongated shapes are spaced apart from one another (if more than one);
said predetermined compact shapes are adjacent elongated shapes representing objects upon which operations represented by said predetermined shapes are executed;
said predetermined compact shapes are connected by lines to elongated shapes representing objects from which operations represented by said predetermined shapes are executed;
different predetermined compact shapes are use to represent operations which modify an object and operations which do not modify an object;
said control segment shapes each define an elongated strip perpendicular to the timeline;
each of said predetermined compact shapes being located in a strip and each section of said timeline being located in a strip such that said operations represented by said predetermined compact shapes in a strip are executed according to said flow control mechanisms represented by said timeline segment located in said strip;
each strip contains a portion of at least one of said elongated shapes such that for each strip it is illustrated that operations on or by said object represented by said at least one elongated shapes are represented by predetermined compact shapes located in said strip and said operations are to be executed according to control mechanisms represented by said timeline segment in said strip.

16. Computer readable media according to claim 15 wherein said process is a software process.

17. A method according to claim 1 wherein said process is a software process.
